(19) United States
(12) Patent Application Publication
(10) Pub. No.: US 2003/0090675 A1
(43) Pub. Date: May 15, 2003

(54) Interferometric methods and apparatus for determining object position while taking into account rotational displacements and warping of interferometer mirrors on the object

(75) Inventor: Tomoharu Fujiwara, Ageo city (JP)

Correspondence Address: KLARQUIST SPARKMAN, LLP, One World Trade Center, Suite 1600, 121 S.W. Salmon Street, Portland, OR, 97204, US

(73) Assignee: Nikon Corporation

(21) Appl. No.: 10/165,403

(22) Filed: Jun. 7, 2002

(30) Foreign Application Priority Data
Jun. 7, 2001 (JP) 2001-172380

(51) Int. Cl. G01B 11/02

(52) U.S. Cl. 356/500

(57) ABSTRACT

Methods are disclosed for determining and accounting for errors in a moving mirror of an interferometer used for determining the position of a stage or the like in a microlithography system or other system requiring highly accurate positioning. In an embodiment, straight lines that approximate respective curves of mirror surfaces (29a), (29b) are determined with respect to a coordinate system defined on a wafer table. The straight lines are determined by a least-squares method. Also determined are angles (Ψᵤ) and (Ψᵥ) formed by straight lines (Lᵤ) and (Lᵥ) relative to coordinate axes (u) and (v), respectively. Intersections with the coordinate axes u, v are (Bᵤ, 0) and (0, Bᵥ), respectively. The distances to points U₁ and V₁ on mirror surfaces 29a and 29b with respect to straight lines Lᵤ and Lᵥ are ωᵤ(v) and ωᵥ(u), respectively, and the angles with the tangent lines of the points U₁ and V₁ are βᵤ(v) and βᵥ(u), respectively. Equations of the mirror surfaces thus are: u=v[Ψᵤ+ωᵤ(v)]+Bᵤ+βᵤ(v), and v=u[Ψᵥ+ωᵥ(u)]+Bᵥ+βᵥ(u).

### FIELD

This disclosure pertains generally to microlithography (transfer-exposure of a pattern, defined on a reticle or mask (generally termed a “reticle” herein), to a “sensitive” substrate. Microlithography is a key technology used in the manufacture of microelectronic devices such as integrated circuits, displays, micromachines, and the like. More specifically, the disclosure pertains to methods for measuring, by interferometry, the position of a stage (reticle stage or substrate stage) as used in a microlithography apparatus. Even more specifically, the disclosure pertains to such methods in which compensations are made for warping of a mirror used for interferometrically measuring position of a stage or other object.

### BACKGROUND

Charged-particle-beam (CPB) microlithography (e.g., electron-beam microlithography) currently is the subject of intensive research and development directed at the development of a practical CPB microlithography system and method. An especially promising approach involves defining the pattern, to be transferred to a substrate, on a “segmented” or “divided” reticle comprising a large number of subfields or other exposure units each defining a respective portion of the pattern to be transferred lithographically to the substrate. This approach is termed “divided-reticle reduction-projection microlithography.” One type of reticle used with this type of microlithography system is a “stencil” reticle in which pattern elements are defined as corresponding stencil apertures in the reticle membrane.

For exposure of the pattern from the reticle to the substrate, the reticle is positioned relative to a CPB-optical system that produces and directs a charged particle beam as used for making the exposure. As the beam (“illumination beam”) illuminates a selected subfield of the reticle, the portion of the beam passing through the illuminated portion (“patterned beam”) acquires an aerial image of the illuminated portion. The CPB-optical system directs the beam to the substrate, which usually is a semiconductor wafer coated with a suitable resist. Exposure of the pattern requires that the subfields on the reticle be illuminated in an ordered manner (usually in a sequential manner). Positioning the subfields relative to the CPB-optical system for exposure requires that the reticle and substrate be movable relative to each other and relative to the CPB-optical system. Thus, exposure is accompanied by respective motions of a reticle stage, to which the reticle is mounted, and substrate stage, to which the substrate is mounted. These respective motions also accomplish proper placement of the subfield images relative to each other on the substrate so as to “stitch” the subfield images together in a contiguous manner. Proper stitching and avoidance of stitching errors require that the subfield images be formed relative to each other on the substrate with extremely high accuracy and precision. Thus, movements and positioning of the reticle stage and substrate stage must be performed with high accuracy and precision.

Typically, stage-position measurements are obtained using an interferometric position-measurement device. In general, an interferometric position-measurement device emits a laser beam toward a mirror (i.e., a reflecting mirror of an interferometer) provided on the subject stage. An interference is produced of light reflected from the mirror with emitted light, and stage position is determined from an analysis of interference fringes that are produced from the interference.

In order to measure the irradiation position of the illumination beam on the reticle stage or the imaging position of the patterned beam on the substrate stage, a respective interferometer device having multiple interferometer axes desirably is used. Such a device allows measurements of respective stage positions along each of the measurement axes (X-axis and Y-axis) as well as rotations (yaw, pitch, and roll) of the respective stage.

If an interferometer device is used in the atmosphere, errors can arise due to variations in the interferometer optical path due to air currents. Fortunately, CPB microlithography is performed in a vacuum environment, which eliminates any significant air currents.

Other sources of error in position determinations determined interferometrically are: (1) an irregularity in the surface of the reflective mirror, and (2) an inadequate calculation algorithm for calculating, from the interferometric data, the position and amount of rotation of the respective stage. One conventional way in which to solve the first problem is to calculate mirror warp in advance (i.e., to “calibrate” the mirror). Mirror warp is determined by performing position measurements of multiple selected points on the mirror surface mounted on the subject stage. The measured values are interpolated and extrapolated as required to obtain a continuous profile of discrepancies (including tilt) of the reflective surface relative to the theoretical plane of the mirror surface. Measurement errors are reduced by incorporating the data obtained during the mirror calibration into computations executed for calculating the position and rotation of the subject stage. Unfortunately, substantial local mirror warp can be undetected by these methods, which can result in substantial error in stage-position and stage-rotation determinations. In other words, even though measurements of local mirror warp conventionally are obtained, the angle of the tangential line at the locus of intersection is not taken into consideration. As a result, for example, a local warp of the mirror surface of approximately 10 μrad can yield a position-determination error of several nm to several tens of nm. In view of modern standards by which microlithography must be performed, these errors cannot be tolerated.

### SUMMARY

In view of the shortcomings of conventional methods as summarized above, the present invention provides, inter alia, interferometrically based position-measurement methods that accurately compensate for deformation and “rotation” of the surface of the interferometer mirror, thereby providing more accurate position measurements than obtainable conventionally.

According to a first aspect of the invention, methods are provided for measuring a position of a movable object using multiple interferometers. The object includes a respective moving mirror associated with each interferometer. In an embodiment of such a method, for each interferometer, a respective measurement-light beam is directed to the respective moving mirror to establish a respective interference between the measurement-light beam reflected from the respective moving mirror and a respective reference light beam. Each measurement-light beam has a respective axis of propagation relative to a respective locus of impingement of the measurement-light beam with the respective moving mirror. From the respective interferences, data are obtained concerning a position of the movable object. From each respective interference, data are obtained concerning: (a) any respective rotation of the movable object, and (b) any warp of the respective moving mirror at the locus of impingement of the respective measurement-light beam at the respective axis on the respective moving mirror. From the data concerning respective warps of the moving mirrors and rotation of the object, the data concerning the position of the object are corrected. Hence, from data concerning warp of the moving mirrors, data are obtained regarding conventional positional dislocations from the respective theoretical planes of the moving mirrors. Also, data concerning localized warping (e.g., mirror-surface-angle error) are taken into account in computing the respective positions and the various amounts of rotation (yaw, pitch, and roll) of the object. Consequently, positional measurements are obtained at higher accuracy and precision than conventionally. In this method embodiment, the step of obtaining data concerning warp includes the step of obtaining data concerning a respective angle error of the respective moving mirror at the locus of impingement.

According to another aspect of the invention, methods are provided for measuring a position of a movable stage relative to an optical axis using multiple interferometers. The stage includes a respective moving mirror associated with each interferometer. In an embodiment of such a method, for each interferometer, multiple respective measurement-light beams are directed to the respective moving mirror to establish interferences between each measurement-light beam reflected from the respective moving mirror and a respective reference light beam. Each measurement-light beam impinges the respective moving mirror at a respective locus of intersection. A stage-coordinate system is established having an origin on an upstream-facing surface of the stage, and an interferometer-coordinate system is established having an origin on the upstream-facing surface of the stage at the optical axis. In the stage-coordinate system, for each locus of intersection on each moving mirror, an equation is obtained that includes: (a) an angle of a tangent line of the moving mirror at the locus of intersection and (b) a rotation error of the stage. The equations are converted into respective equations involving respective coordinates in the interferometer-coordinate system. Respective coordinates of the respective locus of intersection are substituted into the converted equations. From the coordinates of the loci of intersection, the rotation of the stage is determined. In the interferometer-coordinate system, respective optical path lengths of the respective interferometers are obtained. The optical path lengths are substituted with respective coordinates in the interferometer-coordinate system. The respective coordinates in the interferometer-coordinate system are substituted into the respective equations to obtain a target stage position.

In the foregoing embodiment, the equations in the step of obtaining an equation including the angle of curvature of the moving mirror at the locus of intersection and the rotation error of the stage can result in the following equations:

x{(1−θ²/2)+θ[Ψᵤ+ωᵤ(v)]}+y[θ−Ψᵤ−ωᵤ(v)]+uₛ−vₛ[Ψᵤ+ωᵤ(v)]−[Bᵤ+βᵤ(v)]=0

x[−Ψᵥ−ωᵥ(u)−θ]+y{(1−θ²/2)−θ[Ψᵥ+ωᵥ(u)]}+vₛ−uₛ[Ψᵥ+ωᵥ(u)]−[Bᵥ+βᵥ(u)]=0

wherein x and y are coordinates in the interferometer-coordinate system; u and v are coordinates in the stage-coordinate system; θ is an angle of rotation of the stage; each of Ψᵤ and Ψᵥ is a respective angle of a respective line, representing a linear best-fit to a curved surface of a respective moving mirror at a respective locus of intersection, relative to the respective u or v coordinate axis; each of ωᵤ(v) and ωᵥ(u) is a respective angle of a respective tangent line at the respective locus of intersection, relative to the respective u or v coordinate axis; each of Bᵤ and Bᵥ is a respective intersection of the respective best-fit line with the respective u or v coordinate axis; and each of βᵤ(v) and βᵥ(u) is a distance of the respective locus of intersection with the respective best-fit line.

In the step of substituting into the converted equations respective coordinates of the respective locus of intersection, the respective coordinates of the respective locus of intersection can be denoted X₁(x₁, −a/2), X₂(x₂, a/2), Y₁(−a/2, y₁), Y₂(a/2, y₂), wherein x₁, x₂, y₁, y₂ are respective coordinates in the interferometer-coordinate system, and “a” denotes a separation of the beams in each interferometer. Thus, this step can result in the following equations:

x₁=(a/2)(θ−Ψᵤ₁)+vₛΨᵤ₁+(Bᵤ₁−uₛ)[(1+θ²/2)−θΨᵤ₁]

x₂=−(a/2)(θ−Ψᵤ₂)+vₛΨᵤ₂+(Bᵤ₂−uₛ)[(1+θ²/2)−θΨᵤ₂]

y₁=−(a/2)(θ+Ψᵥ₁)+uₛΨᵥ₁+(Bᵥ₁−vₛ)[(1+θ²/2)−θΨᵥ₁]

y₂=(a/2)(θ+Ψᵥ₂)+uₛΨᵥ₂+(Bᵥ₂−vₛ)[(1+θ²/2)−θΨᵥ₂]

wherein Ψᵤ₁=Ψᵤ+ωᵤ)(v₁), Ψᵤ₂=Ψᵤ+ωᵤ(V₂), Ψᵥ₁=Ψᵥ₁=Ψᵥωᵥ(u₁), and Ψᵥ₂=Ψᵥ+ω(u₂); u₁, u₂, v₁, v₂ are respective coordinates in the stage-coordinate system; uₛ and vₛ are respective coordinates of an origin of the stage-coordinate system; and Bᵤ₁=Bᵤ+βᵤ(v₁), Bᵤ₂=Bᵤ+βᵤ(v₂), Bᵥ₁=Bᵥ+βᵥ(u₁), Bᵥ₂=Bᵥ+βᵥ(u₂).

In the foregoing embodiment, the step of obtaining respective optical path lengths of the respective interferometers in the interferometer-coordinate system can result in the following equations:

X₁/4=Lₓ[1−(θ+Ψᵤ₁)²]−(a/2)(θ−Ψᵤ₁)−vₛΨᵤ₁−(Bᵤ₁−uₛ)[(1+θ²/2)−θΨᵤ₁−(θ+Ψᵤ₁)²]

X₂/4=Lₓ[1−(θ+Ψᵤ₂)²]+(a/2)(θ−Ψᵤ₂)−vₛΨᵤ₂−(Bᵤ₂−uₛ)[(1+θ²/2)−θΨᵤ₂−(θ+Ψᵤ₂)²]

Y₁/4=L_{y}[1−(θ+Ψᵥ₁)²]+(a/2)(θ−Ψᵥ₁)−vₛΨᵥ₁−(Bᵥ₁−vₛ)[(1+θ²/2)+θΨᵥ₁−(θ+Ψᵥ₁)²]

Y₂/4=L_{y}[1−(θ+Ψᵥ₂)²]−(a/2)(θ−Ψᵥ₂)−vₛΨᵥ₂−(Bᵥ₂−vₛ)[(1+θ²/2)+θΨᵥ₂−(θ+Ψᵥ₂)²]

wherein each of X₁, X₂, Y₁, Y₂ is an optical path length of the respective interferometer at the respective locus of intersection of the respective interferometer beam; and each of Lₓ and L_{y} is a respective distance from an exposure position to an interference position of the respective interferometer.

According to another aspect of the invention, apparatus are provided for interferometrically measuring a position of a moving object. An embodiment of such an apparatus comprises first and second reflecting members attached to the object so as to move along with the object, wherein the reflecting members being oriented orthogonally to each other. Multiple respective interferometers are arranged in opposition to each of the reflective members. Each interferometer is configured to direct a respective measurement beam to a respective locus on the respective reflective member so as to allow the measurement beam to reflect from the locus. Each interferometer also is configured to detect interference between the respective measurement beam and a reference beam so as to produce respective data concerning a position of the respective locus. The apparatus also includes a computation means situated and configured: (a) to receive the data from the interferometers and to calculate a position of the object and respective angles of tangent lines of the reflective members from the data, (b) to calculate an amount of rotation of the object, and (c) to correct the position data based on the calculated angles of tangent lines and rotation. Respective positions of the reflective members are measured using the multiple interferometers. Correcting the position data is performed by incorporating local warp data of the reflective members at the respective loci of intersection of the respective interferometers.

Contours of the reflective members can be determined either inside or outside of a microlithography apparatus with which the reflective members are used (e.g., in association with a substrate stage or reticle stage of the apparatus). Based on these determinations, the data obtained for ω, Ψ, and β can be stored for later recall. Interpolations and/or extrapolations, as well as least-squares analysis, can be used for obtaining actual values of ω, Ψ, and β, as well as Lᵤ and Lᵥ, as described herein. Based on these data, during exposure using the microlithography apparatus, the respective stage(s) is controlled, taking into account the local variation of the direction of reflection of interferometer light directed at the reflective members (i.e., the angle of the tangential line at the point of incidence of the interferometer light).

According to another aspect of the invention, microlithographic exposure systems are provided. An embodiment of such a system comprises an exposure-optical system and a stage. The stage is situated relative to the exposure-optical system and is configured to be loaded with a reticle or substrate for use in making an exposure. First and second orthogonally arranged moving mirrors are mounted to the stage, wherein each moving mirror has a respective reflective surface. Multiple respective interferometers are associated with each moving mirror. Each interferometer is situated and configured to: (a) direct a respective measurement beam to a respective locus on the reflective surface of the respective mirror, and (b) detect interference between the respective measurement beam and a reference beam so as to produce respective data concerning a position of the respective locus. The system also includes a computation means situated and configured: (a) to receive the data from the interferometers and to calculate a position of the stage and respective warping of the reflective members, (b) to calculate an amount of rotation of the stage, and (c) to correct the position data, based on the calculated warping and rotation, by incorporating into the calculations local warp data of the moving mirrors at the respective loci of intersection of the respective interferometers.

According to yet another aspect of the invention, methods are provided for performing a microlithographic exposure of a pattern from a reticle to a sensitive substrate. In an embodiment of such a method, the substrate is mounted on a substrate stage comprising first and second moving mirrors arranged orthogonally on the substrate stage. Each moving mirror has a respective reflective surface. Multiple measurement beams are directed from respective interferometers to each reflective surface, wherein each measurement beam impinges the respective reflective surface at a respective locus. Respective sets of fringes produced by interference of each measurement beam with a respective reference beam are detected so as to produce respective positional data concerning each locus. From the positional data, the position and rotation of the stage are calculated. The positional data are corrected based on the warp data. The substrate is exposed while controlling the position and rotation of the stage based on the corrected positional data. The step of correcting the positional data is performed by calculations including data concerning warp at each locus.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic plan diagram of an upstream-facing surface of a stage including X-direction and Y-direction moving mirrors. This figure depicts, in an exaggerated manner, warping of the moving mirrors. The figure also depicts several variables and axes, concerning rotation of mirror surfaces, used in calculations disclosed herein.

FIG. 2 is an elevational schematic diagram of an embodiment of an electron-beam microlithography system, including various imaging relationships.

FIG. 3 is an oblique view of an embodiment of a substrate stage as used in the microlithography system of FIG. 2. Shown attached to the stage are respective moving mirrors for each of the X-direction and Y-direction interferometers (not shown).

FIG. 4 is a schematic diagram showing interferometer axes referred to in the embodiments disclosed herein.

FIG. 5 is a schematic diagram showing various optical path lengths of an interferometer that occur during rotation of the respective moving mirror.

### DETAILED DESCRIPTION

The invention is described below in the context of representative embodiments that are not intended to be limiting in any way. The embodiments are described in the context of an electron-beam microlithography system as a representative charged-particle-beam (CPB) microlithography system. It will be understood that the principles described below are applicable with equal facility to microlithography systems utilizing an alternative type of charged particle beam, such as an ion beam, and to microlithography systems utilizing another type of energy beam, such as a VUV beam or X-ray beam. It also will be understood that the stage devices described below can be used in general for positioning of an object in any of various environments, including a vacuum environment.

In addition, although the following description is set forth in the context of using a reticle to define a pattern intended for lithographic transfer to a substrate, the disclosed methods also can be applied to a microlithography system that performs exposure directly onto a substrate without using a reticle.

Representative Embodiment of Microlithography System

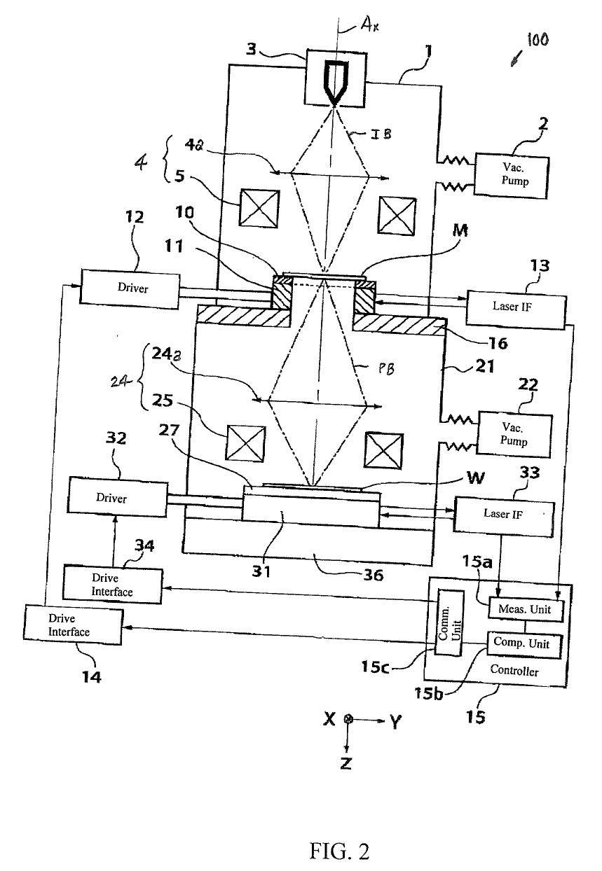

Turning first to FIG. 2, a representative embodiment of an electron-beam microlithography system 100 is shown schematically. The system 100 comprises a first (“upper”) optical column 1 configured as a vacuum chamber in this embodiment. The atmosphere inside the upper optical column 1 is evacuated to a suitable vacuum level using a vacuum pump 2 connected to the upper optical column 1.

An electron gun 3 is situated at the extreme upstream (topmost in the figure) portion of the upper optical column 1, and emits an electron beam (“illumination beam” IB) in a downstream direction (downward in the figure) along an optical axis Ax. Downstream of the electron gun 3 are an illumination-optical system 4 and a reticle M. The illumination-optical system 4 comprises a condenser lens 4a, a deflector 5, and other components as required to cause the illumination beam IB to irradiate a desired region on the reticle M.

The illumination beam IB emitted from the electron gun 3 is condensed by the condenser lens 4a for illuminating the reticle M. The deflector 5 deflects the illumination beam IB in one or more lateral directions (e.g., Y-direction in the figure) on the reticle M within the optical field of the illumination-optical system 4. For example, a reticle M as used for CPB microlithography typically is divided into multiple exposure units (usually configured as “subfields”) that are illuminated by the illumination beam IB in a sequential manner. The exposure units are arrayed in rectilinear columns and rows on the reticle, wherein each row typically has a length (e.g., in the Y-direction in the figure) substantially equal to the width of the optical field of the illumination-optical system 4. In FIG. 2, the illumination-optical system 4 is depicted as having only a single-stage lens (i.e., the condenser lens 4a). An actual illumination-optical system typically has a multiple-stage lens, beam-shaping apertures, and the like.

The reticle M is secured by electrostatic attraction, vacuum suction, or other suitable means to a reticle chuck 10 mounted on an upstream-facing surface of a reticle stage 11. The reticle stage 11, in turn, is mounted on a base 16.

The reticle stage 11 is actuated for movement in at least the X- and Y-directions by a reticle-stage driver 12 operably connected to the reticle stage 11. Although the reticle-stage driver 12 is depicted in the figure to the left of the reticle stage 11, the driver 12 typically is incorporated into the actual mechanism of the reticle stage 11. The reticle-stage driver 12 is connected to a controller 15 via a drive interface 14. In addition, a laser interferometer (IF) 13 is situated relative to the reticle stage 11 (on the right side of the reticle stage 11 in the figure). Actually, the laser interferometer 13 comprises at least two laser interferometers, one for detecting reticle-stage position in the X-direction and another for detecting reticle-stage position in the Y-direction in the figure. For use with these laser interferometers, respective moving mirrors (not shown, but discussed later below) are mounted along respective edges of the reticle stage 11. The outwardly facing side surfaces of the moving mirrors are polished to high precision and used as the reflecting surfaces for the respective laser interferometers.

The laser interferometer 13 is connected to the controller 15 and serves to obtain accurate data concerning the position of the reticle stage 11 in the X-direction and Y-direction. The positional data obtained by the laser interferometer 13 is routed to the controller 15. To position the reticle stage 11 at a target position, a respective command is transmitted from the controller 15 to the drive interface 14. The drive interface 14, in response to the command, appropriately energizes the driver 12 to move the stage 11 to the corresponding position. The components 11-15 functioning in this manner achieve accurate, real-time, feedback control of the position of the reticle stage 11.

A second (“lower”) optical column 21 is situated downstream of the base 16. The lower optical column is configured as a vacuum chamber in this embodiment and also serves as a “wafer chamber.” The atmosphere inside the lower optical column 21 is evacuated to a suitable vacuum level using a vacuum pump 22 connected to the lower optical column 21. Situated inside the lower optical column are a wafer W and a “projection-optical system” 24 including a condenser lens (projection lens) 24a and a deflector 25.

The electron beam passing through the reticle M is termed the “patterned beam” PB. The patterned beam PB is projected by the projection lens 24a and deflected as required by the deflector 25 to form a focused image at a prescribed location on the wafer W of the illuminated region on the reticle M. Although, in the figure, the projection-optical system 24 is depicted as having only a single-stage lens (i.e., the projection lens 24a), the projection-optical system 24 actually includes a multiple-stage (usually two-stage) lens. The optical system can comprise lenses only or lenses and deflector coils as required for proper image formation and for aberration correction. the combination of the illumination-optical system 4 and projection-optical system 24 is the “CPB-optical system” or “exposure-optical system.”

The wafer W is held by electrostatic attraction, vacuum suction, or other suitable means to a wafer chuck 27 mounted on an upstream-facing surface of a wafer stage 31. The wafer stage 31, in turn, is mounted on a base 36.

The wafer stage 31 is actuated for movement in at least the X-direction and Y-direction by a wafer-stage driver 32 operably connected to the wafer stage 31. Although the wafer-stage driver 32 is depicted to the left of the wafer stage 31, the driver 32 typically is incorporated into the actual mechanism of the wafer stage 31 in a manner similar to that of the reticle stage 11. The wafer-stage driver 32 is connected to the controller 15 via a drive interface 34. In addition, a laser interferometer (IF) 33 is situated relative to the wafer stage 31 (on the right side of the wafer stage 31 in the figure). Actually, the laser interferometer 33 comprises at least two laser interferometers, one for detecting wafer-stage position in the X-direction and another for detecting wafer-stage position in the Y-direction in the figure. For use with these laser interferometers, respective moving mirrors (not shown, but discussed later below) are mounted along respective edges of the reticle stage 31. The side surfaces of the outside of the moving mirrors are polished to high precision and used as the reflecting surfaces for the respective laser interferometers. The laser interferometers are connected to the controller 15 and serve to obtain accurate data concerning the position of the wafer stage 31 in the X-direction and Y-direction, respectively. The positional data obtained by the laser interferometer 33 is routed to the controller 15.

To position the wafer stage 31 at a target position, a respective command is transmitted from the controller 15 to the drive interface 34. The drive interface 34, in response to the command, appropriately energizes the driver 32 to move the wafer stage 31 to the corresponding position. The components 31-34 and 15 functioning in this manner achieve accurate, real-time, feedback control of the position of the wafer stage 31.

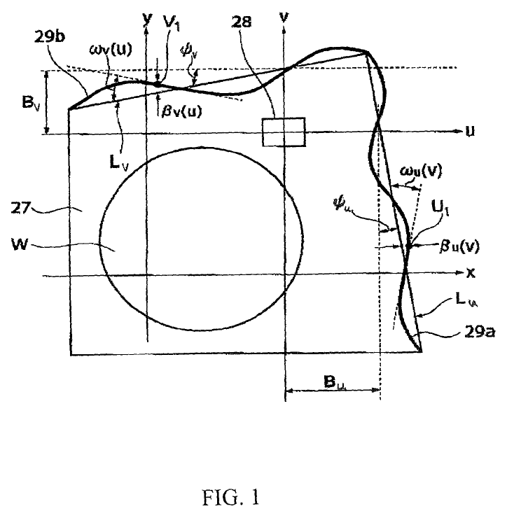

More specifically, the controller 15 comprises a measurement-data processor 15a that calculates the respective positional coordinates of the reticle stage 11 and the wafer stage 31 from data provided by the respective laser interferometers 13, 33. The controller 15 also comprises an arithmetical calculator 15b that performs a variety of computations (discussed in detail below with reference to FIG. 1) from the positional coordinates supplied by the measurement-data processor 15a. The controller 15 also includes a command unit 15c that generates and directs respective commands to the drive interfaces 14, 34 used for controlling respective motions of the stages 11, 31. The respective commands are processed by the respective drive interfaces 14, 34, which route respective actuation signals to the stages 11, 31 so as to achieve target stage positions. Thus, accurate feedback control of the positions of the reticle stage 11 and wafer stage 31 is achieved in real time.

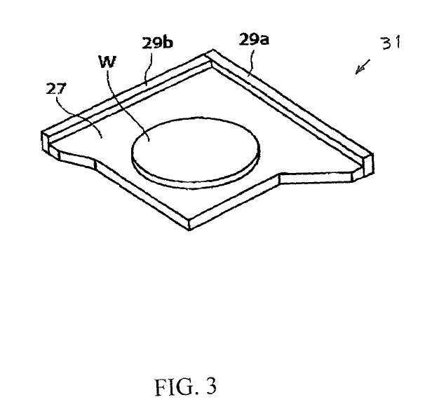

An exemplary embodiment of a wafer stage 31 is shown in FIG. 3. The wafer stage 31 comprises a wafer table 27 that comprises a wafer chuck or analogous device (not shown) by which the wafer W is mounted to the wafer table 27. The wafer chuck can be, e.g., an electrostatic chuck or the like. Moving mirrors 29a, 29b are installed along two edges of the wafer table 27. The side outside surface of each moving mirror 29a, 29b is polished to high precision and used as the respective reflecting surface for the respective laser interferometers 33 (FIG. 2).

Representative Embodiments of Methods and Devices for Measuring Mirror Rotation

A representative embodiment of a method for measuring respective positions and amounts of rotation of the moving mirrors 29a, 29b on the wafer table 31 is now described. Here, in the interest of simplicity, the method is described in the context of measurements in a two-dimensional plane. Also, it is understood that a “warp” or other deviation of a location on the surface of a moving mirror from ideal absolute planarity is manifest effectively as a “rotation” of that location.

The method comprises the following actions:

(1) On the upstream-facing surface of the wafer table 27, a rectangular coordinate system (u, v) is established. (This is the “wafer-table coordinate system.”) For the (u, v) coordinate system a mark on a mark plate 28 on the wafer table 27 serves as the origin. An “interferometer coordinate system” (x, y) also is established, having an origin at the center of the exposure-optical system. The center of the exposure-optical system is the optical axis Ax.

(2) In the (u, v) coordinate system, equations are obtained for respective points on each of the moving mirrors. The equations include respective local angles of curvature of the moving mirrors Ψᵤ+ωᵤ(vᵢ), Ψᵥ+ωᵥ(uᵢ).

(3) Rotation error of the wafer table 27 is incorporated into the equations mentioned in (2), above.

(4) The equations are converted into respective interferometer coordinates (x, y).

(5) The intersections of all four interferometer axes (two respective axes for the X-direction interferometer and two respective axes for the Y-direction interferometer) are substituted into the equations noted above, and respective coordinates (x₁, x₂, y₁, y₂) of the intersections are calculated.

(6) In the (x, y) coordinate system, the respective optical path lengths of the interferometers are obtained after determining “rotation” of the moving mirrors.

(7) The coordinates (x₁, x₂, y₁, y₂) are substituted for the optical path lengths noted in (6), above.

(8) The coordinates measured by the interferometers are substituted into the equations to obtain final target exposure positions, and the wafer table is controllably moved and held at the respective positions.

The variables summarized above are illustrated in FIG. 1. Certain relationships concerning the variables as used for determining the respective positions and rotation of the moving mirrors on the wafer table 27 also are shown in FIG. 1. A wafer W is shown in the vicinity of the center of the wafer table 27. The mark plate 28 is situated adjacent the edge of the wafer W. The outwardly facing side surfaces of the moving mirrors 29a, 29b (termed “mirror surfaces” herein) are shown schematically along the right side and “upper” side (in the figure), respectively, of the wafer table 27. In a greatly exaggerated manner, FIG. 1 depicts respective warping (planarity deviations) in the mirror surfaces 29a, 29b. FIG. 1 also depicts the (u, v) coordinate system (wafer-table coordinate system) having an origin in the center of the mark plate 28 and the (x, y) coordinate system (interferometer coordinate system) having an origin in the center of the exposure-optical system.

Referring further to FIG. 1, straight lines Lᵤ, Lᵥ are shown that approximate the curves of the mirror surfaces 29a, 29b, respectively, by respective least-squares fits. Coordinates on the lines are in the (u, v) coordinate system. Note that the lines Lᵤ, Lᵥ are extrapolated lines used in conventional position-measurement methods using interferometers. The angles formed by the straight lines Lᵤ and Lᵥ relative to their respective coordinate axes u and v are Ψᵤ and Ψᵥ, respectively, and the intersections of the lines Lᵤ, Lᵥ with the coordinate axes u, v are (Bᵤ, 0) and (0, Bᵥ) respectively. The distances of certain points on the mirror surfaces 29a, 29b (for example, the points U₁ and V₁, respectively) with respect to the lines Lᵤ and Lᵥ, respectively, are βᵤ(v) and βᵥ(u), respectively. The angles of respective tangent lines of the points U₁ and V₁ on the respective mirror surfaces 29a and 29b are ωᵤ(v) and ωᵥ(u), respectively. (Note that, in conventional compensation methods, the angles ωᵤ(v) and ωᵥ(u) were not considered.)

As noted above, the curves 29a, 29b greatly exaggerate respective warping of the mirror surfaces 29a, 29b. I.e., the warp actually is very small. Consequently, Ψᵤ, Ψᵥ, ωᵤ(v), and ωᵥ(u) are very small. The angle Ψᵤ is measured from the v-axis to the line Lᵤ; the angle ωᵤ is measured from the line Lᵤ to the respective mirror surface; the angle Ψᵥ is measured from the line Lᵥ to the u-axis; and the angle ωᵥ is measured from the reflecting surface to the line Lᵥ. In the figure the clockwise direction is regarded as a “positive” angle.

Equations for the mirror surfaces 29a, 29b are expressed as follows.

u=tan[Ψᵤ+ωᵤ(v)]v+Bᵤ+βᵤ(v) (Eq. 1)

v=tan[Ψᵥ+ωᵥ(u)]u+Bᵥ+βᵥ(u) (Eq. 2)

Since the terms pertaining to curvature angles (warping), namely [Ψᵤ+ωᵤ(v)] and [Ψᵥ+ωᵥ(u)], are very small, Equations 1 and 2 can be approximated as follows:

u=v[Ψᵤ+ωᵤ(v)]+Bᵤ+βᵤ(v) (Eq. 3)

v=u[Ψᵥ+ωᵥ(u)]+Bᵥ+βᵥ(u) (Eq. 4)

Next, the rotation error of the wafer table 27 is incorporated into Equations 3 and 4. If the coordinates of the exposure position (i.e., the origin of the interferometer coordinate system (x, y)) on the wafer W (in the wafer-table coordinate system (u, v)) are denoted (uₛ, vₛ), and the matrix indicating the amount of rotation of the wafer table 27 is denoted R, then the following equation is obtained:

$$( \begin{matrix}x \\ y\end{matrix} ) = R ( \begin{matrix}u - {u}_{s} \\ v - {v}_{s}\end{matrix} ) \qquad ( Eq . 5 )$$

If the rotation of the wafer table 27 is denoted θ, then the rotation of the wafer table is expressed as:

$$R = ( \begin{matrix}cos θ & - sin θ \\ sin θ & cos θ\end{matrix} ) \qquad ( Eq . 6 )$$

Substituting Equation 6 into Equation 5 yields:

$$( \begin{matrix}x \\ y\end{matrix} ) = ( \begin{matrix}cos θ & - sin θ \\ sin θ & cos θ\end{matrix} ) ( \begin{matrix}u - {u}_{s} \\ v - {v}_{s}\end{matrix} ) \qquad ( Eq . 7 )$$

Rearranging Equation 5 yields the following:

$$( \begin{matrix}u \\ v\end{matrix} ) = {R}^{- 1} ( \begin{matrix}x \\ y\end{matrix} ) + ( \begin{matrix}{u}_{s} \\ {v}_{s}\end{matrix} ) \qquad ( Eq . 8 )$$

Substituting Equation 5 into Equation 8 yields:

$$( \begin{matrix}u \\ v\end{matrix} ) = ( \begin{matrix}cos θ & sin θ \\ - sin θ & cos θ\end{matrix} ) ( \begin{matrix}x \\ y\end{matrix} ) + ( \begin{matrix}{u}_{s} \\ {v}_{s}\end{matrix} ) \qquad ( Eq . 9 )$$

According to Maclaurin's theorem:

$$\begin{matrix}cos θ = 1 - \frac{{θ}^{2}}{2} + \frac{{θ}^{4}}{4 !} - … & ( Eq . 10 ) \\ sin θ = θ - \frac{{θ}^{3}}{3 !} + \frac{{θ}^{5}}{5 !} - … & ( Eq . 11 )\end{matrix}$$

Since θ actually is very small, third-order and higher terms can be omitted, yielding the following:

cos θ=1−θ²/2 (Eq. 12)

sin θ=θ (Eq. 13)

If Equations 12 and 13 are substituted into Equation 9, Equation 9 can be approximated as follows:

$$( \begin{matrix}u \\ v\end{matrix} ) = ( \begin{matrix}1 - {θ}^{2} / 2 & θ \\ - θ & 1 - {θ}^{2} / 2\end{matrix} ) ( \begin{matrix}x \\ y\end{matrix} ) + ( \begin{matrix}{u}_{s} \\ {v}_{s}\end{matrix} ) \qquad ( Eq . 14 )$$

Substituting Equation 14 into Equations 3 and 4 yields the following:

x{(1−θ²/2)+θ[Ψᵤ+ωᵤ(v)]}+y[θ−Ψᵤ−ωᵤ(v)]+uₛ−vₛ[Ψᵤ+ωᵤ(v)]−[Bᵤ+βᵤ(v)]=0 (Eq. 15)

x[−Ψᵥ−ωᵥ(u)−θ]+y{(1−θ²/2)−θ[Ψᵥ+ωᵥ(u)]}+vₛ−uₛ[Ψᵥ+ωᵥ(u)]−[Bᵥ+βᵥ(u)]=0 (Eq. 16)

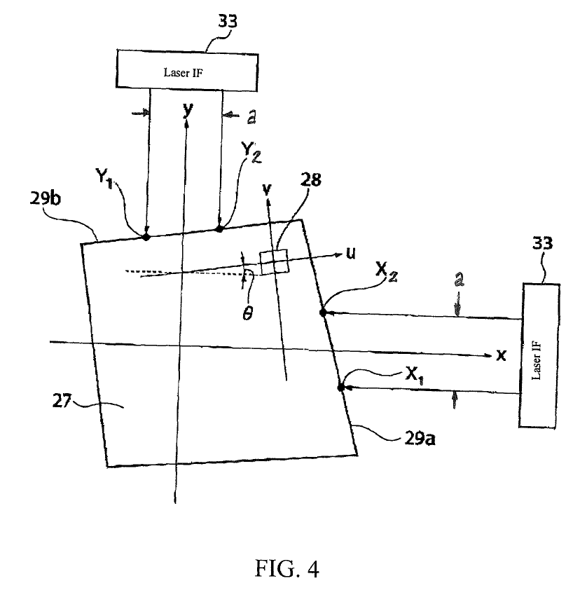

An exemplary arrangement of interferometer axes is depicted in FIG. 4, illustrating the intersections of the interferometer axes (x, y) and the mirror surfaces. Also shown are the wafer table 27, the mark plate 28, the wafer-table coordinate system (u, v) intersecting on the mark plate 28, and the moving mirrors 29a, 29b. The wafer-table coordinate system (u, v) is inclined relative to the interferometer coordinate system (x, y) by an angle θ. Each mirror surface 29a, 29b is irradiated by two laser beams from the respective laser interferometer 33. For each interferometer 33, the respective beams are separated from each other by a distance “a”. The respective (x, y) coordinates on the surfaces of the mirrors 29a, 29b of the respective points of intersection of the surfaces with the respective interferometer axes are X₁(x₁, −a/2), X₂(x₂, a/2), Y₁(−a/2, y₁), and Y₂(a/2, y₂), respectively.

Substituting X₁ into Equation 15 and rearranging yields the following:

X₁={(1+θ²/2)−θ[Ψᵤ+ωᵤ(v₁)]}×{(a/2)[θ−Ψᵤ−ωᵤ(v₁)]−uₛ+vₛ[Ψᵤ+ωᵤ(v₁)]+[Bᵤ+βᵤ(v₁)]} (Eq. 17)

If the following relationships are applicable:

Ψᵤ₁=Ψᵤ+ωᵤ(v₁) (Eq. 18)

Bᵤ₁=Bᵤ+βᵤ(v₁) (Eq. 19)

then Equation 17 can be written:

x₁32 [(1+θ²/2)−θΨᵤ₁][(a/2)(θ−Ψᵤ₁)−uₛ+vₛΨᵤ₁+Bᵤ₁] (Eq. 20)

Rearrangement yields the following:

x₁=(a/2)(θ−Ψᵤ₁)+vₛΨᵤ₁+(Bᵤ₁−uₛ)[(1+θ²/2)−θΨᵤ₁] (Eq. 21)

Substituting X₂ into Equation 15, and individually substituting each of Y₁ and Y₂ into Equation 16, followed by rearranging terms, yields the following, respectively:

x₂=−(a/2)(θ−Ψᵤ₂)+vₛΨᵤ₂+(Bᵤ₂−uₛ)[(1+θ²/2)−θΨᵤ₂] (Eq. 22)

y₁=−(a/2)(θ+Ψᵥ₁)+uₛΨᵥ₁+(Bᵥ₁−vₛ)[(1+θ²/2)+θΨᵥ₁] (Eq. 23)

y₂=(a/2)(θ+Ψᵥ₂)+uₛΨᵥ₂+(Bᵥ₂−vₛ)[(1+θ²/2)+θΨᵥ₂] Eq. 24)

Thus, in the interferometer coordinate system (x, y), the respective lengths of the optical paths of the interferometers that result whenever the moving mirrors 29a, 29b are rotated are obtained.

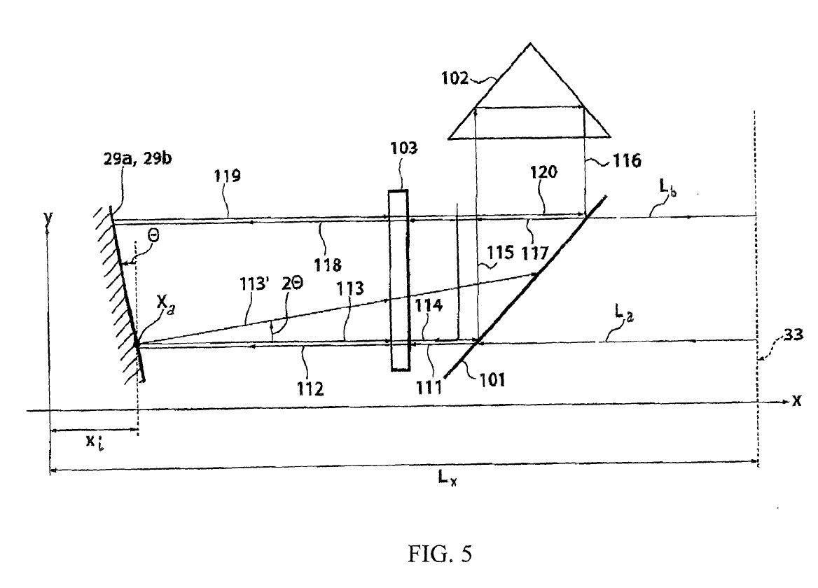

The respective optical path lengths of the interferometers after rotation of the moving mirrors are depicted in FIG. 5, in which the optical path of a position-measurement interferometer utilizing a comer cube such as that disclosed in Japan Kôkai Patent Document No. Hei 11-44503 is shown. The interferometer comprises a polarizing beam splitter (PBS) 101 that transmits p-polarized light (having a polarization azimuth in the X-direction) and reflects s-polarized light (having a polarization azimuth in the Y-direction). The interferometer also includes a corner-cube prism 102 and a quarter-wavelength plate (λ/4 retarder) 103 consisting of optical elements such as a Fresnel rhomb. A surface 29a of a moving mirror is shown schematically, and the interference position of the laser interferometer 33 is indicated by the dashed lines. The laser beam incident from a light source is denoted Lₐ, and the reflected beam, measured by the laser interferometer 33, is denoted L_{b}.

In FIG. 5, the laser beam Lₐ is incident to the PBS 101, through which p-polarized light is transmitted. The beam 111 of p-polarized light becomes a beam of circularly polarized light 112 by passage through the quarter-wavelength plate 103. The beam 112 of circularly polarized light is incident to the mirror surface 29a. A beam 113 of circularly polarized light reflected from the mirror surface 29a passes back through the quarter-wavelength plate 103 and thus becomes s-polarized light 114. The s-polarized light 114 returns to the PBS 101. The s-polarized beam 114 is reflected by the PBS 101 “upward” (in the figure) as the beam 115. The beam 115 is incident to the comer-cube prism 102, in which the beam is reflected twice. The reflected beam 116, propagating in the “downward” direction in the figure, is s-polarized light. Thus, the beam 116 is reflected by the PBS 101 in the leftward direction in the figure as the beam 117. This s-polarized beam 117 becomes a beam 118 of circularly polarized light 118 by passage through the quarter-wavelength plate 103. The beam 118 is incident to the mirror surface 29a. The circularly polarized light beam 119 reflected by the mirror surface 29a becomes a beam 120 of p-polarized light by passage through the quarter-wavelength plate 103. The beam 120 returns to the PBS 101 and, because the beam 120 is p-polarized, passes through the PBS 101. The beam 120 proceeds “rightward” in the figure as the reflection laser beam L_{b}.

As shown, the mirror surface 29a in the vicinity of the beams 112, 118 is inclined by the angle Θ relative to the y-axis of the interferometer coordinate system. Whenever the laser beam Lₐ and the beams 111, 112 are directed, in parallel to the x-axis, from the laser interferometer 33 toward the point Xₐ of the mirror surface 29a, the laser beam 113′ reflected from the point Xₐ is reflected at an angle of 2Θ relative to the x-axis. The laser beam 113′ reaches the interferometer 33 in the manner discussed above via the PBS 101, the corner-tube prism 102, etc.

The optical path length of the interferometer is denoted X₁; the distance from the exposure position (i.e., the origin of the x-axis and y-axis) to the point Xₐ of the mirror surface 29a is denoted xᵢ; and the distance from the exposure position to the interference position of the interferometer 33 is denoted Lₓ. Regarding these variables, the following equations are applicable:

Xᵢ=4(Lₓ−xᵢ)(1−Θ²) (Eq. 25)

Here, included in Θ are the rotation error θ of the wafer table and the local angles of curvature Ψᵤᵢ and Ψᵥᵢ of the mirrors. Hence, whenever Xₐ=X₁ (FIG. 4):

Θ=θ+Ψᵤ₁ (Eq. 26)

Substituting Equation 26 into Equation 25 yields the following:

X₁/4=(Lₓ−xᵢ)[1−(θ+Ψᵤ₁)²] (Eq. 27)

Substituting Equation 21 into Equation 27 yields the following:

X₁/4=Lₓ[1−(θ+Ψᵤ₁)²]−(a/2)(θ−Ψᵤ₁)−vₛΨᵤ₁−(Bᵤ₁−uₛ)[(1+θ²/2)−θΨᵤ₁−(θ+Ψᵤ₁)²] (Eq. 28)

If Xₐ=X₂, Y₁, or Y₂ (FIG. 4), similar calculations yield the following:

X₂/4=Lₓ[1−(θ+Ψᵤ₂)²]+(a/2)(θ−Ψᵤ₂)−vₛΨᵤ₂₋₍Bᵤ₂−uₛ)[(1+θ²/2)−θΨᵤ₂−(θ+Ψᵤ₂)²] (Eq. 29)

Y₁/4=L_{y}[1−(θ+Ψᵥ₁)²]+(a/2)(θ−Ψᵥ₁)−vₛΨᵥ₁−(Bᵥ₁−vₛ)[(1+θ²/2)+θΨᵥ₁−(θ+Ψᵥ₁)²] (Eq. 30)

Y₂/4=L_{y}[1−(θ+Ψᵥ₂)²]−(a/2)(θ−Ψᵥ₂)−vₛΨᵥ₂−(Bᵥ₂−vₛ)[(1+θ²/2)+θΨᵥ₂−(θ+Ψᵥ₂)²] (Eq. 31)

Substituting the values (X₁, X₂, Y₁, and Y₂), as determined using the interferometer, into Equations 28-31, respectively, results in obtaining respective values of (Lₓ, L_{y}). These values, used for solving for θ, uₛ, and vₛ, are used for controllably positioning the wafer stage 27 for exposure.

Equations 28-31 take into consideration local mirror warping at the respective positions on the mirror where the laser beams strike. Local angle-of-curvature parameters already have been incorporated into the foregoing equations as the coefficients u and v. As a result, approximate positions of the intersections of laser beams with the mirrors during measurements can be determined by the following method.

Whenever interference data, obtained for example as the stage is being moved continuously, is read during a short period of time, the angles of mirror curvature Ψᵤᵢ and Ψᵥᵢ at the positions predicted from data obtained during the immediately proceeding position determination are used. Thus, it is possible to obtain a predicted position of the laser beam within an accuracy of several tens of nm with respect to the true value. If the mirror-curvature period is at least approximately several tens of μm, adequate accuracy and precision are achieved.

By incorporating the local angles of curvature Ψᵤᵢ and Ψᵥᵢ of the mirrors into the interferometer-calculation equations (Equations 28-31), it is possible to improve measurement accuracy and precision substantially.

The foregoing description was directed to measurements made in two dimensions. It will be understood that highly accurate determinations also can be made by taking into account local angles of curvature of mirrors in the case where the interferometer axes are laid out three-dimensionally. Also, although the embodiment described above was described in the context of a wafer table, it will be understood that the same principles can be applied with equal facility to a reticle stage and to applications not involving a stage at all. For example, the principles can be applied to positional determinations of a fixed lens assembly relative to a lens column.

Whereas the invention was described above in the context of representative embodiments, the invention is not limited to those embodiments. On the contrary, the invention is intended to encompass all alternatives, modifications, and equivalents as may be included within the spirit and scope of the invention, as defined by the appended claims.

What is claimed is:

1. A method for measuring a position of a movable object using multiple interferometers, the object including a respective moving mirror associated with each interferometer, the method comprising:
for each interferometer, directing a respective measurement-light beam to the respective moving mirror to establish a respective interference between the measurement-light beam reflected from the respective moving mirror and a respective reference light beam, each measurement-light beam having a respective axis of propagation relative to a respective locus of impingement of the measurement-light beam with the respective moving mirror;
from the respective interferences, obtaining data concerning a position of the movable object;
from each respective interference, obtaining data concerning (i) any respective rotation of the movable object, and (ii) any warp of the respective moving mirror at the locus of impingement of the respective measurement-light beam at the respective axis on the respective moving mirror, wherein obtaining data concerning warp comprises obtaining data concerning a respective angle error of the respective moving mirror at the locus of impingement; and
from the data concerning respective warps of the moving mirrors and rotation of the object, correcting the data concerning the position of the object.

2. A method for measuring a position of a movable stage relative to an optical axis using multiple interferometers, the stage including a respective moving mirror associated with each interferometer, the method comprising:
(a) for each interferometer, directing multiple respective measurement-light beams to the respective moving mirror to establish interferences between each measurement-light beam reflected from the respective moving mirror and a respective reference light beam, each measurement-light beam impinging the respective moving mirror at a respective locus of intersection;
(b) establishing a stage-coordinate system having an origin on an upstream-facing surface of the stage, and an interferometer-coordinate system having an origin on the upstream-facing surface of the stage at the optical axis;
(c) in the stage-coordinate system, for each locus of intersection on each moving mirror, obtaining an equation that includes (i) an angle of a tangent line to the moving mirror at the locus of intersection and (ii) a rotation error of the stage;
(d) converting the equations into respective equations involving respective coordinates in the interferometer-coordinate system;
(e) substituting into the converted equations respective coordinates of the respective locus of intersection;
(f) determining from the coordinates of the loci of intersection the rotation of the stage;
(g) in the interferometer-coordinate system, obtaining respective optical path lengths of the respective interferometers;
(h) substituting the optical path lengths with respective coordinates in the interferometer-coordinate system; and
(i) substituting the respective coordinates in the interferometer-coordinate system into the respective equations to obtain a target stage position.

3. The method of claim 2, wherein the equations in step (c) are:
x{(1−θ²/2)+θ[Ψᵤ+ωᵤ(v)]}+y[θ−Ψᵤ−ωᵤ(v)]+uₛ−vₛ[Ψᵤ+ωᵤ(v)]−[Bᵤ+βᵤ(v)]=0
x[−Ψᵥ−ωᵥ(u)−θ]+y{(1−θ²/2)−θ[Ψᵥ+ωᵥ(u)]}+vₛ−uₛ[Ψᵥ+ωᵥ(u)]−[Bᵥ+βᵥ(u)]=0
wherein x and y are coordinates in the interferometer-coordinate system; u and v are coordinates in the stage-coordinate system; θ is an angle of rotation of the stage; each of Ψᵤ and Ψᵥ is a respective angle of a respective line, representing a linear best-fit to a curved surface of a respective moving mirror, relative to the respective u or v coordinate axis; each of ωᵤ(v) and ωᵥ(u) is a respective angle of a respective tangent line at a respective locus of intersection, relative to the respective u or v coordinate axis; each of Bᵤ and Bᵥ is a respective intersection of the respective best-fit line with the respective u or v coordinate axis; and each of βᵤ(v) and βᵥ(u) is a distance of the respective locus of intersection with the respective best-fit line.

4. The method of claim 3, wherein, in step (e), the respective coordinates of the respective locus of intersection are X₁(x₁, −a/2), X₂(x₂, a/2), Y₁(−a/2, y₁), Y₂(a/2, y₂), wherein x₁, x₂, y₁, y₂ are respective coordinates in the interferometer-coordinate system, and a denotes a separation of the beams in each interferometer.

5. The method of claim 4, wherein step (e) results in the following equations:
x₁=(a/2)(θ−Ψᵤ₁)+vₛΨᵤ₁+(Bᵤ₁−uₛ)[(1+θ²/2)−θΨᵤ₁]
x₂=−(a/2)(θ−Ψᵤ₂)+vₛΨᵤ₂+(Bᵤ₂−uₛ)[(1+θ²/2)−θΨᵤ₂]
y₁=−(a/2)(θ+Ψᵥ₁)+uₛΨᵥ₁+(Bᵥ₁−vₛ)[(1+θ²/2)+θΨᵥ₁]
y₂=(a/2)(θ+Ψᵥ₂)+uₛΨᵥ₂+(Bᵥ₂−vₛ)[(1+θ²/2)+θΨᵥ₂]
wherein Ψᵤ₁=Ψᵤ+ωᵤ(v₁), Ψᵤ₂=Ψᵤ+ωᵤ(V₂), Ψᵥ₁=Ψᵥ₁=Ψᵥ+ωᵥ(u₁), and Ψᵥ₂=Ψᵥ+ω(u₂); u₁, u₂, v₁, v₂ are respective coordinates in the stage-coordinate system; uₛ and vₛ are respective coordinates of an origin of the stage-coordinate system; and Bᵤ₁=Bᵤ+βᵤ(v₁), Bᵤ₂=Bᵤ+βᵤ(v₂), Bᵥ₁=Bᵥ+βᵥ(u₁), Bᵥ₂=Bᵥ+βᵥ(u₂).

6. The method of claim 5, wherein step (g) results in the following equations:
X₁/4=Lₓ[1−(θ+Ψᵤ₁)²]−(a/2)(θ−Ψᵤ₁)−vₛΨᵤ₁−(Bᵤ₁−uₛ)[(1+θ²/2)−θΨᵤ₁−(θ+Ψᵤ₁)²]
X₂/4=Lₓ[1−(θ+Ψᵤ₂)²]+(a/2)(θ−Ψᵤ₂)−vₛΨᵤ₂−(Bᵤ₂−uₛ)[(1+θ²/2)−θΨᵤ₂−(θ+Ψᵤ₂)²]
Y₁/4=L_{y}[1−(θ+Ψᵥ₁)²]+(a/2)(θ−Ψᵥ₁)−vₛΨᵥ₁−(Bᵥ₁−vₛ)[(1+θ²/2)+θΨᵥ₁−(θ+Ψᵥ₁)²]
Y₂/4=L_{y}[1−(θ+Ψᵥ₂)²]−(a/2)(θ−Ψᵥ₂)−vₛΨᵥ₂−(Bᵥ₂−vₛ)[(1+θ²/2)+θΨᵥ₂−(θ+Ψᵥ₂)²]
wherein each of X₁, X₂, Y₁, Y₂ is an optical path length of the respective interferometer at the respective locus of intersection of the respective interferometer beam; and each of Lₓ and L_{y} is a respective distance from an exposure position to an interference position of the respective interferometer.

7. An apparatus for interferometrically measuring a position of a moving object, the apparatus comprising:
first and second reflecting members attached to the object so as to move along with the object, the reflecting members being oriented orthogonally to each other;
multiple respective interferometers arranged in opposition to each of the reflective members, each interferometer being configured to direct a respective measurement beam to a respective locus on the respective reflective member so as to allow the measurement beam to reflect from the locus, each interferometer being configured to detect interference between the respective measurement beam and a reference beam so as to produce respective data concerning a position of the respective locus; and
computation means situated and configured (a) to receive the data from the interferometers and to calculate a position of the object and respective angles of tangent lines of the reflective members from the data provided by the interferometers, (b) to calculate an amount of rotation of the object, and (c) to correct the position data based on the calculated tangent-line angles and rotation;
wherein respective positions of the reflective members are measured using the multiple interferometers, and correcting the position data is performed by incorporating local warp data of the reflective members at the respective loci of intersection of the respective interferometers.

8. A microlithographic exposure system, comprising:
an exposure-optical system;
a stage situated relative to the exposure-optical system and configured to be loaded with a reticle or substrate for use in making an exposure;
first and second orthogonally arranged moving mirrors mounted to the stage, each moving mirror having a respective reflective surface;
multiple respective interferometers associated with each moving mirror, each interferometer being situated and configured to (a) direct a respective measurement beam to a respective locus on the reflective surface of the respective mirror, and (b) to detect interference between the respective measurement beam and a reference beam so as to produce respective data concerning a position of the respective locus; and
computation means situated and configured (a) to receive the data from the interferometers and to calculate a position of the stage and respective warping of the reflective members, (b) to calculate an amount of rotation of the stage, and (c) to correct the position data, based on the calculated warping and rotation, by incorporating into the calculations local warp data of the moving mirrors at the respective loci of intersection of the respective interferometers.

9. A method for performing a microlithographic exposure of a pattern from a reticle to a sensitive substrate, comprising:
mounting the substrate on a substrate stage comprising first and second moving mirrors arranged orthogonally on the substrate stage, each moving mirror having a respective reflective surface;
directing multiple measurement beams from respective interferometers to each reflective surface, each measurement beam impinging the respective reflective surface at a respective locus;
detecting respective sets of fringes produced by interference of each measurement beam with a respective reference beam so as to produce respective positional data concerning each locus;
from the positional data, calculating position and rotation of the stage;
correcting the positional data based on the warp data; and
performing exposure of the substrate while controlling the position and rotation of the stage based on the corrected positional data;
wherein the step of correcting the positional data is performed by calculations including data concerning warp at each locus.
